(19) United States
(12) Patent Application Publication
(10) Pub. No.: US 2019/0344406 A1
(43) Pub. Date: Nov. 14, 2019

(54) QUICK RELEASE DEVICE OF RATCHET WRENCH

(71) Applicant: Yi-Fu Chen, Taichung City (TW)

(72) Inventor: Yi-Fu Chen, Taichung City (TW)

(21) Appl. No.: 15/974,698

(22) Filed: May 9, 2018

(51) Int. Cl. B25B 13/46

(52) U.S. Cl. CPC B25B 13/463; B25B 23/0007

(57) ABSTRACT

A quick release device of a ratchet wrench includes a rotary ring rotatably mounted to a positioning member on the head of the wrench. When the rotary ring is rotated, a movable plate is driven to a positioning position or a releasing position. When the movable plate is located at the engaging position, a contact portion of the movable plate is engaged with one of multiple recessed portions of the rotary ring, and an engaging portion of the movable plate is engaged with a groove of a socket that is connected to the ratchet wheel of the wrench. When the movable plate is located at the releasing position, the contact portion contacts with one of the protrusions of the rotary ring, and the engaging portion is disengaged from the groove of the socket so that the socket can be quickly removed from the wrench.

### BACKGROUND OF THE INVENTION

### 1. Fields of the Invention

The present invention relates to a ratchet wrench, and more particularly, to a quick release device of a ratchet wrench for quickly releasing socket from the ratchet wrench.

### 2. Descriptions of Related Art

The conventional quick release device of a ratchet wrench known to applicant is combined with the switch device. The user pivots the switch device to change the ratcheting directions of the ratchet wheel of the wrench. The user may also pull upward and push downward the switch device to control the connection between the socket, for example, and the ratchet wrench.

However, the switch device is operated in four different directions makes the switch device be complicated in structure.

The present invention intends to provide a quick release device of a ratchet wrench that is designed to eliminate the drawbacks mentioned above.

### SUMMARY OF THE INVENTION

The present invention relates to a quick release device of a ratchet wrench, and the ratchet wrench comprises a head having a through hole defined through the top face and the bottom face thereof. A ratchet wheel is rotatably received in the through hole and engaged with a pawl that is received in a recess defined in the inner periphery of the through hole. A positioning member is formed on the top face of the head and has an opening. A rotary ring is rotatably mounted to the positioning member and has a touch portion and a driving portion. The driving portion has multiple recessed portions and multiple protrusions in radial direction. The multiple protrusions are located alternatively relative to the recessed portions. A recessed area is defined in the top face. The opening of the positioning member communicates with the recessed area. A spring is axially located in the recessed area. A cover is fixedly engaged with the recessed area.

A movable plate is movably located in the cover and has an engaging portion formed on the first end thereof. A contact portion is formed on the movable plate and located close to the first end of the movable plate. Both of the engaging portion and the contact portion face the driving portion of the rotary ring. The second end of the movable plate is biased toward the rotary ring by the spring. The movable plate is moved between an engaging position and a releasing position. When the movable plate is located at the engaging position, the contact portion is engaged with one of the recessed portions of the rotary ring, and the engaging portion is engaged with a groove of a socket that is connected to the ratchet wheel. When the movable plate is located at the releasing position, the contact portion contacts with one of the protrusions of the rotary ring, and the engaging portion is disengaged from the groove of the socket.

Preferably, the rotary ring includes frictional face defined in the outer periphery thereof.

Preferably, a ramp is formed between any two adjacent recessed portion and protrusion.

Preferably, the recessed area includes a cavity defined in the surface thereof, and the spring is received in the cavity. The movable plate includes a tail which is inserted into the cavity and biased by the spring.

Preferably, the engaging portion of the movable plate is located at the first end of the movable plate. The contact portion is located at a distance from the first end of the movable plate.

Preferably, the recessed area includes a room defined in the surface thereof, and the room communicates with the cavity. The movable plate includes an elongate hole which is located corresponding to the room. The cover has a bore which is located corresponding to the room. A shank of a switch member extends through the elongate hole and is rotatably located in the room.

Preferably, the cover includes a slot which is located corresponding to the opening of the positioning member. The movable plate is slidably engaged with the slot.

The advantages of the present invention are that the movable plate is moved between the engaging position and the releasing position by rotating the rotary ring so as to easily secure or release the socket from the wrench.

The user can easily operate the rotary ring by the finger of the hand that holds the wrench.

The rotational action of the rotary ring is transferred into linearly movement of the movable plate.

The operation of the rotary ring and the movement of the movable plate are both proceeded along the top face of the wrench, so that no action that is vertical to the head of the wrench is needed.

The parts that control the engaging action and releasing action of the socket relative to the wrench independent relative to the part that control the ratcheting direction of the ratchet wheel.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a ratchet wrench with the quick release device of the present invention;

FIG. 2 is an exploded view of the ratchet wrench and the quick release device of the present invention;

FIG. 3 is another exploded view of the ratchet wrench and the quick release device of the present invention;

FIG. 4 is a cross sectional view of the wrench and the quick release device of the present invention, wherein a socket is connected to the wrench;

FIG. 5 is another cross sectional view of the wrench and the quick release device of the present invention, wherein the movable plate is moved to a releasing position and the socket is disengaged from the movable plate;

FIG. 6 is an cross sectional view, taken along line VI-VI of FIG. 4, and

FIG. 7 is a cross sectional view, taken along line VII-VII of FIG. 5.

### DETAILED DESCRIPTION OF THE PREFERRED EMBODIMENT

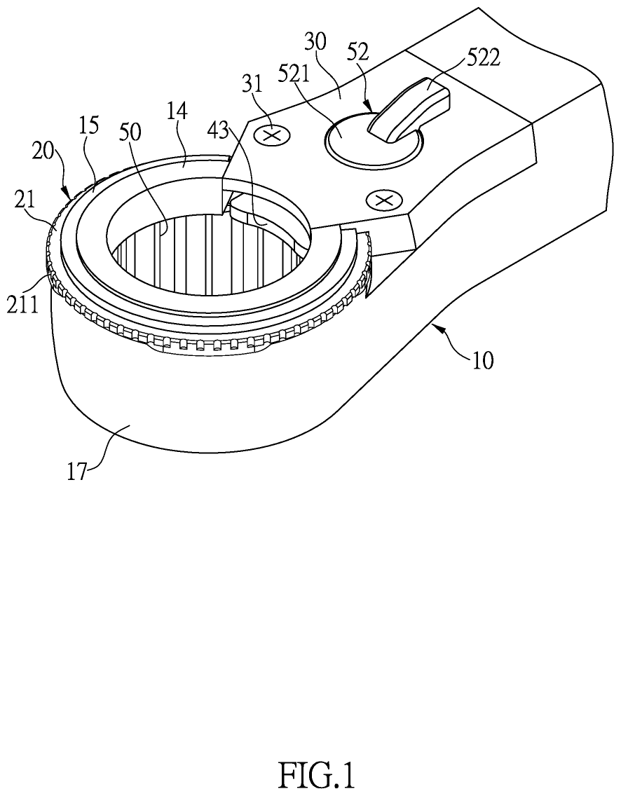

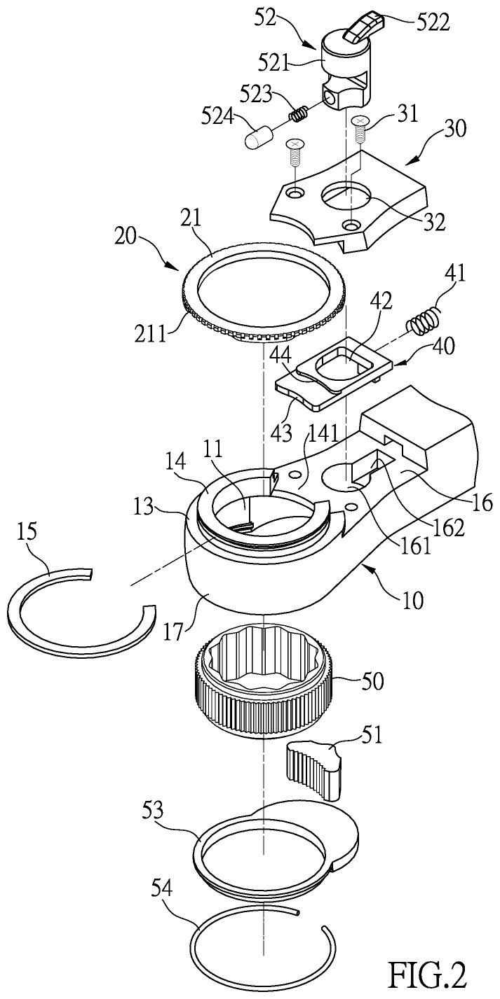

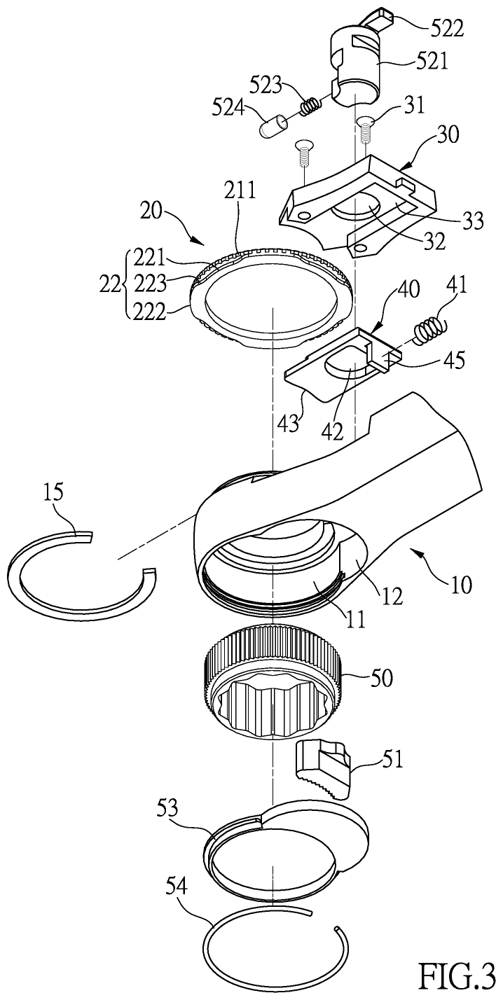

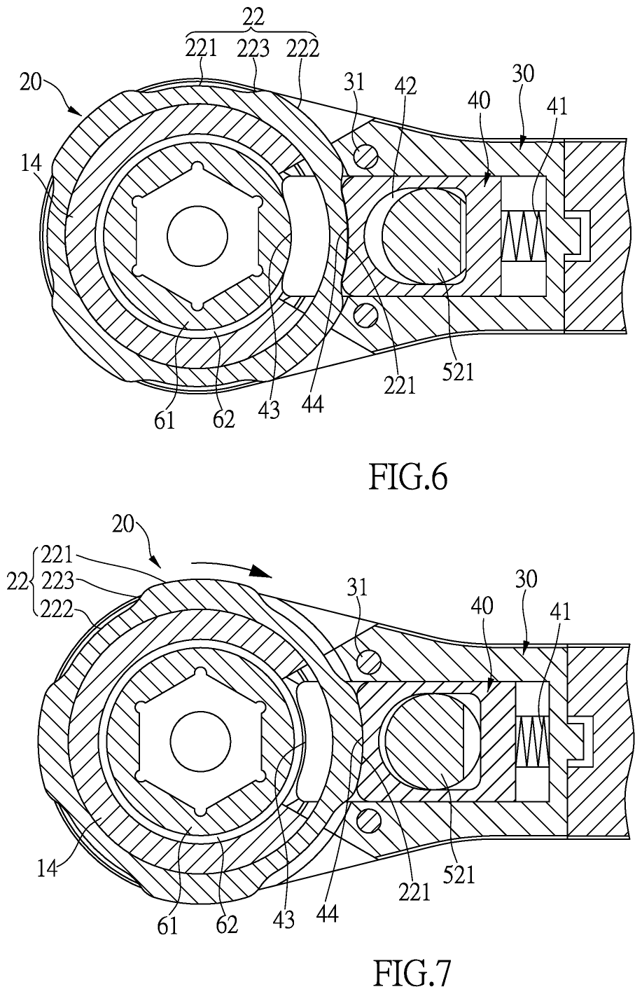

Referring to FIGS. 1 to 4, the ratchet wrench of the present invention comprises a head 10 having a through hole 11 defined through the top face 13 and the bottom face thereof. A ratchet wheel 50 is rotatably received in the through hole 11. A recess 12 is defined in the inner periphery of the through hole 11, and a pawl 51 is movably received in the recess 12 and engaged with the ratchet wheel 50. A ceiling member 53 and a clip 54 are used to seal the through hole 11 from the bottom face of the head 10 to retain the ratchet wheel 50 in the through hole 11. A positioning member 14 is formed on the top face 13 of the head 10 and has an opening 141. A rotary ring 20 is rotatably mounted to the positioning member 14, and a clip 15 is mounted to the positioning member 14 to restrict the rotary ring 20 from disengaging from the positioning member 14. The rotary ring 20 has a touch portion 21 and a driving portion 22, wherein the driving portion 22 includes multiple recessed portions 221 and multiple protrusions 222 in the radial direction of the rotary ring 20. The multiple protrusions 222 are located alternatively relative to the recessed portions 221. A ramp 223 is formed between any two adjacent recessed portion 221 and protrusion 222 as shown in FIGS. 6 and 7. The rotary ring 20 further includes a frictional face 211 defined in the outer periphery thereof. The outer periphery of the rotary ring 20 slightly protrudes beyond the outer periphery 17 of the head 10 so that the user can easily rotate the rotary ring 20.

A recessed area 16 is defined in the top face 13, and the opening 141 of the positioning member 14 communicates with the recessed area 16. The recessed area 16 includes a cavity 162 and a room 161 respectively defined in the surface thereof, and the cavity 162 communicates with the room 161. A spring 41 is axially received in the cavity 162 of the recessed area 16.

A cover 30 is fixedly engaged with the recessed area 16 by multiple fastening members 31. The cover 30 includes a slot 33 defined in the underside thereof, and the slot 33 is located corresponding to the opening 141 of the positioning member 14. A bore 32 is defined through the cover 30. A movable plate 40 movably engaged with the slot 33 of the cover 30 and has an engaging portion 43 formed on the first end thereof, and a contact portion 44 is formed on the movable plate 40 and located close to the first end of the movable plate 40. Specifically, the engaging portion 43 of the movable plate 40 is located at the first end of the movable plate 40, and the contact portion 44 is located at a distance from the first end of the movable plate 40. Both of the engaging portion 43 and the contact portion 44 face the driving portion 22 of the rotary ring 20. The second end of the movable plate 40 includes a tail 45 that extends perpendicularly from the second end of the movable plate 40 and is inserted into the cavity 162 and biased by the spring 41. The movable plate 40 further includes an elongate hole 42 which is located corresponding to the room 161.

A switch member 52 includes a shank 521 and a lever 522 that extends radially from the top of the shank 521. The shank 521 of the switch member 52 extends through the bore 32 and the elongate hole 42, and is rotatably located in the room 161. A recess is defined radially in the shank 521, and a spring 523 and a push member 524 are received in the recess of the shank 521. The push member 524 is pushed by the spring 523 to push the pawl 51 to change the ratcheting directions of the wrench.

As shown in FIGS. 1, 4 and 6, by the force from the spring 41, the movable plate 40 moves toward the opening 141 of the positioning member 14 and reaches to the engaging portion. The engaging portion 43 of the movable plate 40 passes through the opening 141 and enters into the through hole 11, and located above the ratchet wheel 50 so that the movable plate 40 does not affect the operation of the ratchet wheel 50. The contact portion 44 is engaged with one of the recessed portions 221. A socket 60 has a ratchet portion 61 defined in one end thereof which extends through the ratchet wheel 50. A groove 62 is defined in the outer periphery of the socket 60, and the engaging portion 43 of the movable member 40 is engaged with the groove 62 of the socket 60 so that the socket 60 does not drop from the ratchet wheel 50. When the ratchet wrench rotates, the ratchet wheel 50 drives the socket 60 to output toque to an object engaged with the socket 60.

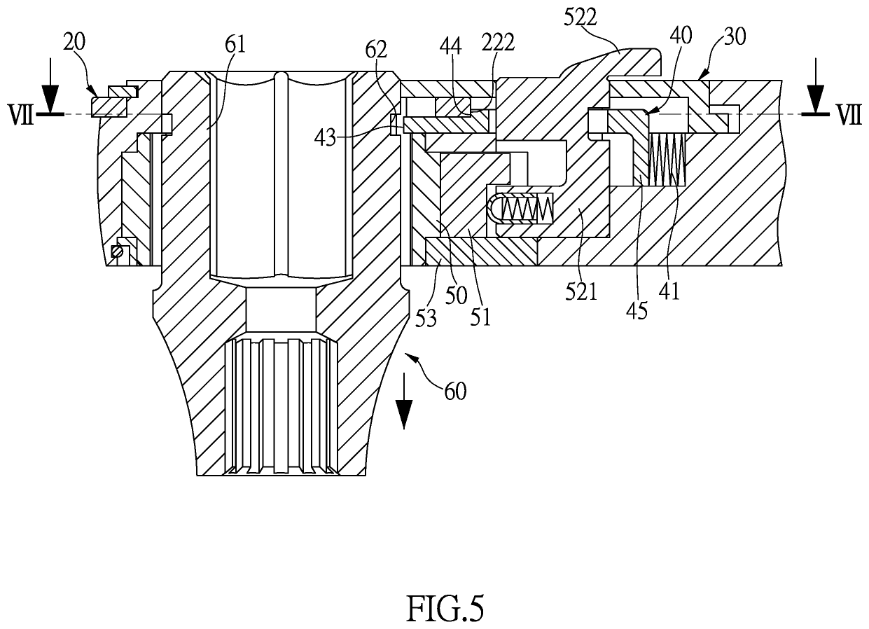

As shown in FIGS. 5 and 7, when releasing the socket 60, the user switches the touch portion 21 of the rotary ring 20 by his/her finger, and the driving portion 22 of the rotary ring 20 pushes the contact portion 44 of the movable plate 40 so that the movable plate 40 moves away from the socket 60 and compresses the spring 41 to reach to the releasing position. Therefore, the engaging portion 43 of the movable plate 40 is removed from the groove 62 of the socket 60, so that the socket 60 can be separated from the ratchet wheel 50. The protrusion 222 of the rotary ring 20 contacts the contact portion 44 of the movable plate 40 to maintain the movable plate 40 at the releasing position, and another part can be connected to the ratchet wheel 50.

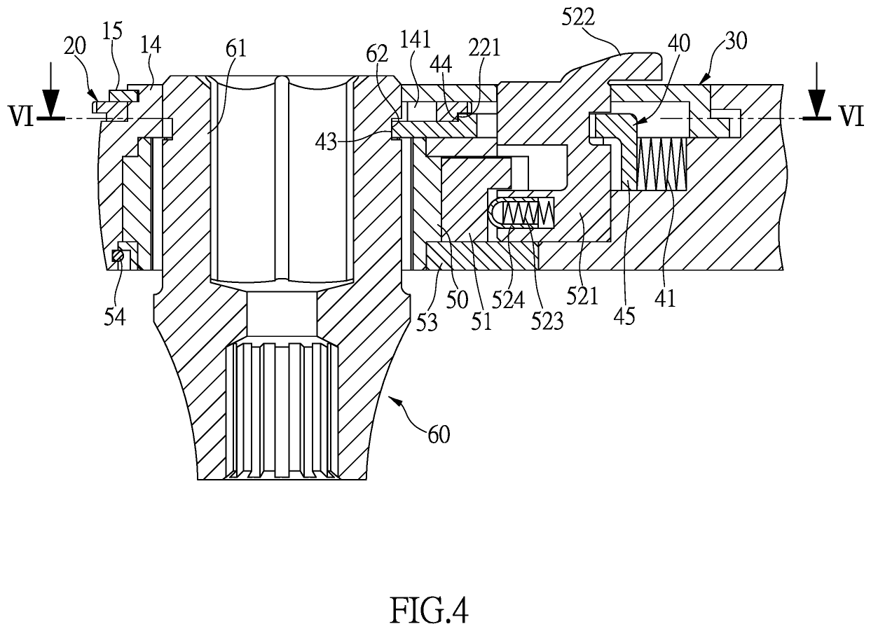

As shown in FIGS. 4 and 6, after the socket 60 is replaced, the rotary ring 20 is rotated again to remove the protrusion 222 from the contact portion 44, and one of the recessed portions 221 is located corresponding to the contact portion 44. The spring 41 pushes the movable plate 40 to the engaging position again. When rotary ring 20 is rotated, the ramp 223 between the protrusion 222 and the recessed portions 221 smoothly pushes the contact portion 444 so that the rotation of the rotary ring 20 is easily operated.

While we have shown and described the embodiment in accordance with the present invention, it should be clear to those skilled in the art that further embodiments may be made without departing from the scope of the present invention.

What is claimed is:

1. A quick release device of a ratchet wrench, comprising:
a head having a through hole defined through a top face and a bottom face thereof, a ratchet wheel rotatably received in the through hole, a recess defined in an inner periphery of the through hole, a pawl movably received in the recess and engaged with the ratchet wheel;
a positioning member formed on the top face of the head and having an opening;
a rotary ring rotatably mounted to the positioning member and having a touch portion and a driving portion, the driving portion having multiple recessed portions and multiple protrusions in radial direction, the multiple protrusions located alternatively relative to the recessed portions;
a recessed area defined in the top face, the opening of the positioning member communicating with the recessed area, a spring axially located in the recessed area;
a cover fixedly engaged with the recessed area;
a movable plate movably located in the cover and having an engaging portion formed on a first end thereof, a contact portion formed on the movable plate and located close to the first end of the movable plate, both of the engaging portion and the contact portion facing the driving portion of the rotary ring, a second end of the movable plate being biased toward the rotary ring by the spring, the movable plate being moved between an engaging position and a releasing position, when the movable plate is located at the engaging position, the contact portion is engaged with one of the recessed portions of the rotary ring, and the engaging portion is engaged with a groove of a socket that is connected to the ratchet wheel, when the movable plate is located at the releasing position, the contact portion contacts with one of the protrusions of the rotary ring, and the engaging portion is disengaged from the groove of the socket.

2. The quick release device of a ratchet wrench as claimed in claim 1, wherein the rotary ring includes a frictional face defined in an outer periphery thereof.

3. The quick release device of a ratchet wrench as claimed in claim 1, wherein a ramp is formed between any two adjacent recessed portion and protrusion.

4. The quick release device of a ratchet wrench as claimed in claim 1, wherein the recessed area includes a cavity defined in a surface thereof, and the spring is received in the cavity, the movable plate includes a tail which is inserted into the cavity and biased by the spring.

5. The quick release device of a ratchet wrench as claimed in claim 1, wherein the engaging portion of the movable plate is located at the first end of the movable plate, the contact portion is located at a distance from the first end of the movable plate.

6. The quick release device of a ratchet wrench as claimed in claim 1, wherein the recessed area includes a room defined in a surface thereof, and the room communicates with the cavity, the movable plate 40 includes an elongate hole which is located corresponding to the room, the cover has a bore which is located corresponding to the room, a shank of a switch member extends through the elongate hole and rotatably located in the room.

7. The quick release device of a ratchet wrench as claimed in claim 1, wherein the cover includes a slot which is located corresponding to the opening of the positioning member, the movable plate is slidably engaged with the slot.
